(19) United States
(12) Patent Application Publication
(10) Pub. No.: US 2006/0196290 A1
(43) Pub. Date: Sep. 7, 2006

(54) Bevel gear drive

(76) Inventor: Frank Stubner, Ernstroda (DE)

Correspondence Address: DAVIS & BUJOLD, P.L.L.C., 112 PLEASANT STREET, CONCORD, NH, 03301, US

(21) Appl. No.: 10/561,692

(22) PCT Filed: Jun. 7, 2004
(86) PCT No.: PCT/EP04/06119

§ 371 Date: Dec. 22, 2005

(30) Foreign Application Priority Data
Jul. 3, 2003 (DE) 103 30 032.5

(51) Int. Cl. F16H 1/14

(52) U.S. Cl. 74/423

(57) ABSTRACT

A bevel gear transmission without shims, especially for a controllable wheel of a service vehicle such as a lift truck, with a one-piece housing for the acceptance of a bevel gearset, a plurality of bearing borings, for the support of a pinion gear shaft, a UniPack bearing and a sealing cover. The sealing cover (2) is placed at a position at which the vertical borings (3, 4) for the bearings (5, 6) of the pinion gear shaft (7) are to be placed, and the cover being provided with a circumferential protrusion (8), which enables that an appropriately dimensioned tool can be vertically introduced into the one-piece housing (1) for a precise construction of the housing which is designed to the closely tolerated dimensions of sections (A) and (B).

This application is a national stage completion of PCT/EP2004/006119 filed Jun. 7, 2004 which claims priority from German Application Serial No. 103 30 032.5 filed Jul. 3, 2003.

### FIELD OF THE INVENTION

The present invention concerns a bevel gear transmission without shims or adjustment spacers and especially concerns a bevel gear transmission for one controllable wheel of a service vehicle, such as a fork lift truck. The bevel gear transmission possesses a one-piece housing to confine a set of bevel gears, a crown gear and a plurality of borings for the support of a bevel pinion shaft.

### BACKGROUND OF THE INVENTION

DE-A-198 26 067 makes known a transmission for one steerable drive wheel of a service vehicle with a transmission housing, which can be mounted in a vehicle chassis and pivots about a vertical axis. An electric motor surmounts this housing, its drive shaft axis being coaxial to the pivot axis. The motor output is controlled by a spur gear stage comprised of a pinion and a spur gear. Further, the gearing includes a second ratio stage determined by a pinion shaft and a crown gear, whereby the pinion of the spur gear stage can be non-rotatably bound to the output shaft of the electric motor. Also, the spur gear is non-rotatably connected to the vertical pinion shaft of the second ratio stage, and the crown gear of the second ratio stage can be non-rotatably affixed to the drive wheel by way of a horizontal output shaft.

Upon acceleration or sudden braking of the service vehicle, the required high ratio of the second ratio stage activates a substantial reaction force on the pinion bearing. In a case of increasing loading requirements, the load capacity of the pinion bearing and the active toothing nears a maximum. In order that greater loading may be carried, without increasing outside dimensioning, the second ratio stage of this known transmission has been designed as a hypoid gearset with a positive axle offset. In this way, it becomes possible to increase the loading, especially on the bearing of the pinion and its toothing.

The transmission, inclusive of the drive wheel, is installed to be pivotally supported in bearings about a vertical motor axle in the service vehicle. The inner ring of the pivotal bearing is integrated into the upper part of a housing component, which, together with the lower housing section forms the complete housing. A pinion of a spur gear/pinion combination is affixed to the motor shaft, wherein this pinion meshes with a spur gear, which is fastened on a free, upper end of a vertical pinion shaft belonging to a hypoid gearset. The toothed area of the hypoid pinion is located at the free lower end of the pinion shaft, which in turn is supported by two roller bearings in the lower part of the housing. The crown gear of the hypoid gearset is non-rotatably bound with a horizontal output shaft by way of a force-fit connection, that is, a bevel press-fit. The horizontal output shaft is supported in the lower part of the housing and is connected to the circumference of the drive wheel.

EP-A-1 285 803 teaches of a single wheel drive arrangement, which is likewise designed for service vehicles. This design is powered by a flanged drive motor driving a controllable wheel operating from a transmission housing and comprises at least one gear stage. In order to hold the construction space as small as possible and to simplify mounting and disassembly, the controllable wheel is non-rotatingly and directly connected with a gear of the transmission. The connected gear itself is rotatably seated on a coaxial, internally located support element of the housing. Insofar as the gear is supported to rotate on a housing pin or is non-rotatably supported on a shaft extension, which penetrates the housing, it is possible that the flange shaft with its bearing elements can be dispensed with, so that a one-part housing can be used, which requires neither a cover nor bolted sections. With the same installation space for the transmission, it is possible further that a larger bevel gear can be installed, which can be used for direct power introduction to the controllable wheel.

The transmission itself is of a two stage design, whereby the first stage is applied to the drive motor with a spur gear meshing, while the second stage regulates the controllable wheel with a bevel gear mesh. The two transmission stages are bound together by a drive shaft supported in the housing, while the controllable wheel is non-rotatable bound with the output drive side bevel gear and a controllable wheel gearset and/or the bevel gear, by way of bearing elements on the housing pin or the shaft extension. Since both the spur gear as well as the bevel pinion can be affixed on the drive shaft before the installation, this adjustment assures a good surface wear pattern as well as advantageous internal clearances for the spiral and circular toothing of the designed bevel gear transmission.

The housing is built in one-piece, whereby a first opening to the driving motor and a second opening to the controllable wheel are provided. In this way, the mounting and the disassembly of the single wheel drive works is made easier. The first opening can be closed by a threaded connection with the inner ring of the ring mount bearing after being installed and the second opening is shut by the bevel gear and a clamping cover.

For the required adjustment of the axial position of the bevel pinion toothing, that is to say, of the bevel gear, spacers or shims are appropriate to align the bearing.

This known bevel gear transmission, as well as all other conventional bevel gear transmissions, are still burdened by the disadvantage, that the bevel gearsets, independently of their design, must be continually under adjustment, that means, that the tolerances of the individual construction components, which bring about a faultless functioning of the bevel gear transmission, including the bevel gearset itself, must be adjusted in such a manner, that a desirable tooth engagement is assured, when considering the desirable surface wear pattern and the circumferential backlash. To this purpose as already mentioned above in connection with the known one-wheel transmission disclosed by EP-A-1 285 803, a plurality of spacers or shims are necessary, as well as the need for frequent individual work-steps in which shims must be selected of unknown specifications.

Further, it has been found to be disadvantageous, that, first, a high demand for time is called for, not only during the necessary mounting, alignment and the corresponding measurement, but also second, the subjective attitude of the erector plays a role. Accordingly, an erector for the assembly should have a great deal of experience.

It is the purpose of the present invention, to create a bevel gear transmission, which requires no spacers or shims for adjustment during its assembly.

### SUMMARY OF THE INVENTION

In accord with the invention, provision has also been made, that the bevel gear transmission, without shims, especially intended for the controllable wheel of a lift truck, with a one-piece housing to confine a bevel gearset, a spur gear, several borings for bearings for the support of a pinion gear shaft, a UniPack bearing set, and a sealing cover, wherein the sealing cover is placed at a specified location, wherein vertical bearing borings for the support of the pinion gear shaft are to be made. The sealing cover is also provided with a circumferential protrusion, which enables finding the exact location for the vertical introduction of an appropriately dimensioned tool into the one-piece housing. This allows for precise construction with very close clearances in the dimensional structure to be made in the housing.

With this arrangement, not only the advantage will be achieved, that shim adjustments are eliminated, but also fewer components are necessary, so that a simpler assembly is gained, which leads to substantial economical savings.

Advantageously, the assembly of the housing for the bevel gear transmission, in accord with its dimensioning, is carried out in a jig for the purpose.

The standard width tolerance of the prefabricated UniPack bearing is compacted to such a degree, that it, together with the installation dimensions of the crown gear, falls into allowable clearances and causes the use of the shims to be redundant.

Advantageously, the tolerance window of the circumferential backlash is so increased, that by fabrication of the components with proper consideration of the tolerances, the desired end-dimensioning of the assembly can be assured in a process safe manner.

### BRIEF DESCRIPTION OF THE DRAWINGS

The invention will now be described, by way of example, with reference to the accompanying drawings in which:

FIG. 1 is a schematic cross-section through the invented bevel gear transmission; and

FIG. 2 is a top view onto the sealing cover.

### DETAILED DESCRIPTION OF THE INVENTION

Bevel gear transmissions of the kind described in the introductory passages, as intended for lift trucks and the like, are well known to the expert. On this account, in the following, only those parts necessary for the understanding of the invention need be described.

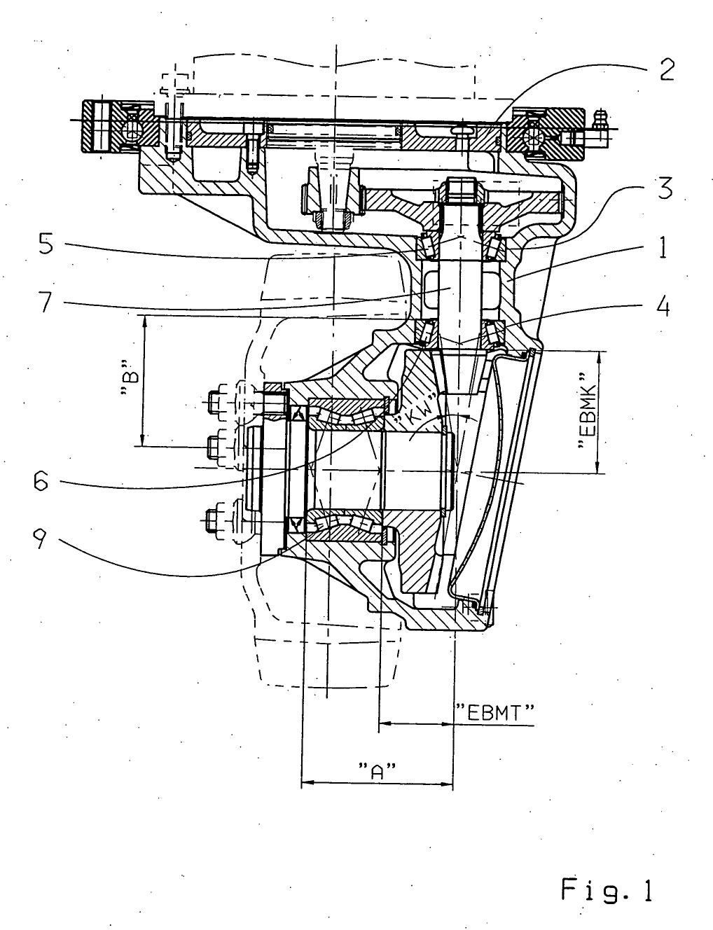

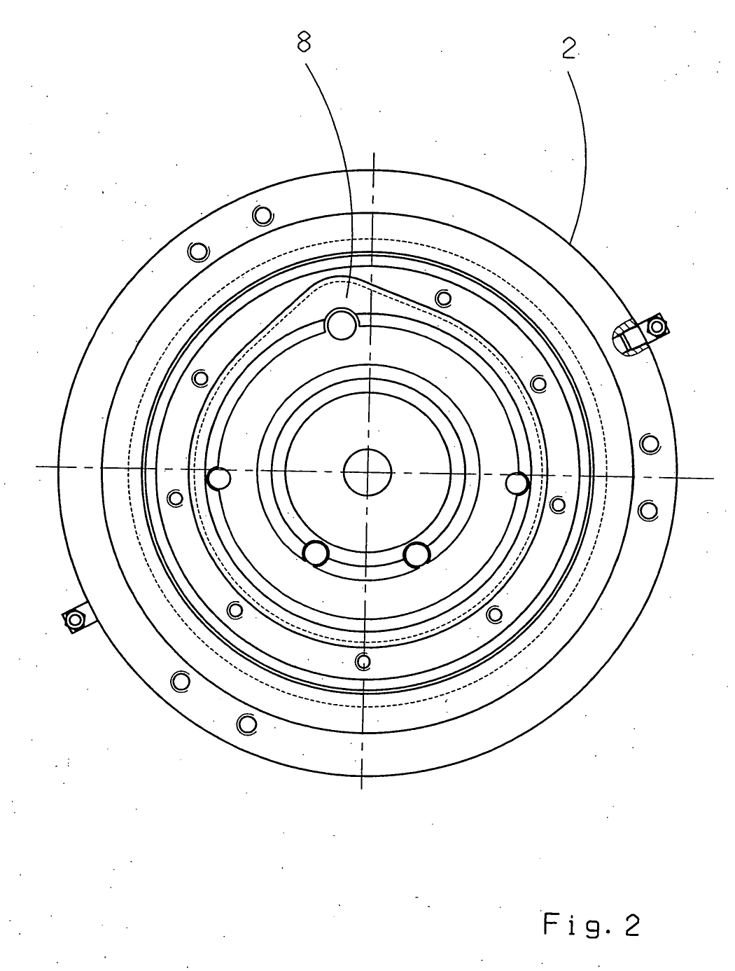

In order to achieve the purpose of the invention, which is to create a bevel gear transmission, wherein during its assembly no spacers or shims are required, as may be inferred from FIG. 1, a one-piece housing 1 is so shaped, that the housing dimensions A and B can be made in a chuck or jig. To carry this out without problems, the sealing cover 2 is shaped so that a circumferential protrusion 8 allows the vertical borings 3, 4 for the bearings 5, 6, which support the pinion gear shaft 7 to be precisely located. As may be seen in FIG. 2, this enables a correspondingly custom made tool of appropriate dimensions to be introduced into the one-piece housing 1 in a vertical direction. Thereby, a considerable degree of precision and procedural safety is gained in the assembly of the dimensioned objects A and B, which are to be built to very close tolerances. This close dimensioning is necessary, in order to mount within the housing 1, a bevel gear transmission, which does not require further adjustment.

Further, the width tolerance of the already, preadjusted bearing 9, which, advantageously, is a UniPack Bearing, is reduced to the extent, that it, together with the crown gear of installation dimensioning EBMT, can be accommodated in the allowable tolerance window. Accordingly, with this filling, a further shim adjustment is not necessary. On the other hand, the longitudinal clearance of the bearing 6 need not also be reduced, since its influence, together with that of the dimensioning EBMK of the pinion gear shaft, on the wear pattern and on the circumferential backlash is very small, due to a reduced bevel angle KW.

As an additional measure, the tolerance window of the circumferential backlash is so increased, that in the course of a tolerance-perfect fabrication of the individual components, the specified final assembled dimensioning can be attained.

By way of the invented formulation of the housing for the bevel gear transmission and the therewith possible reduction of the tolerances, a bevel gear transmission may be obtained, with which no corrections are necessary during the assembly process. Further the invented bevel gear transmission is simpler in its assembly than the conventional bevel gear transmission and is less expensive in time and money to fabricate.

### REFERENCE NUMERALS

1 housing
2 sealing cover
3 boring for bearing
4 boring for bearing
5 bearing
6 bearing
7 pinion gear shaft
8 circumferential protrusion on 2
9 UniPack bearing

1-4. (canceled)

5. A bevel gear transmission without shims, for a controllable wheel of a service vehicle, the transmission comprising a one-piece housing to confine a bevel gearset, a crown gear, a plurality of bearing borings for bearings of a bevel pinion gear shaft, a spur gear stage, which precedes the bevel gearset, and drives the pinion gear shaft, the crown gear is supported by bearings in the housing by a UniPack bearing, and in that the housing is constructed as one-piece and fully confines the bevel gearset and the spur gearing, and the bevel gear transmission possesses a sealing cover, which covers an opening of the housing in an area of the spur gearing, the sealing cover (2) is placed at a location, at which vertical bearing borings (3, 4) for the bearings (5, 6) of the bevel pinion gear shaft (7) are to be made, and said sealing cover is provided with a circumferential protrusion (8), which allows an appropriately dimensioned tool to be vertically introduced into the one-piece housing (1) for exact boring of precise, close tolerance bearing borings for the tapered pinion gear shafts (A, B), the bearing boring for the bevel pinion gear shaft can be made in said housing completely in a jig.

6. The bevel gear transmission according to claim 5, wherein a width tolerance of the UniPack bearing (9) is so limited, that it, together with dimensions (EMBT) of the crown gear falls into an acceptable tolerance window, which advantage causes use of a shim to be redundant.

7. The bevel gear transmission according to claim 5, wherein a tolerance window of a circumferential back lash is so enlarged, that during an assembly, when consideration is given to proper tolerances, fabrication of individual components results in an assembly which is procedure safe and within limits of specified mounted dimensioning.

8. A bevel gear transmission without shims, for a controllable wheel of a service vehicle, the transmission comprising;
a one-piece housing to confine a bevel gearset, a crown gear, a plurality of bearing borings for bearings of a bevel pinion gear shaft, and a spur gear stage, which precedes the bevel gearset, and drives the pinion gear shaft,
the crown gear is supported in the housing by a UniPack bearing, the housing fully confines the bevel gearset and the spur gearing;
a sealing cover of the bevel gear transmission covers an opening of the housing in an area of the spur gearing, the sealing cover (2) is placed at a location on the housing at which vertical bearing borings (3, 4) for the bearings (5, 6) of the bevel pinion gear shaft (7) are to be made, and the sealing cover is provided with a circumferential protrusion (8), for allowing an appropriately dimensioned tool to be vertically introduced into the housing (1) for exact boring of precise, close tolerance bearing borings for the tapered pinion gear shafts (A, B), the bearing boring for the bevel pinion gear shaft can be made in the housing completely in a jig.
